(19) United States
(12) Patent Application Publication
(10) Pub. No.: US 2021/0231344 A1
(43) Pub. Date: Jul. 29, 2021

(54) AIR HANDLING UNIT

(71) Applicant: CARRIER CORPORATION, Palm Beach Gardens, FL (US)

(72) Inventors: Jianwei Zhao, Shanghai (CN); Robert Hong-Leung Chiang, Shanghai (CN); Qing Lu, Shanghai (CN); Xiaowei Wu, Shanghai (CN); Fujin Yang, Shanghai (US)

(21) Appl. No.: 15/734,495

(22) PCT Filed: Sep. 6, 2019
(86) PCT No.: PCT/US2019/049966

§ 371 Date: Dec. 2, 2020

(30) Foreign Application Priority Data
Sep. 14, 2018 (CN) 201821505321.7

(51) Int. Cl. F24F 13/28; F24F 8/108; F24F 11/79; F24F 110/50; F24F 11/81

(52) U.S. Cl. CPC F24F 13/28; F24F 8/108; F24F 11/81; F24F 2110/50; F24F 11/79

(57) ABSTRACT

The application provides an air handling unit, comprising: an air flow path having an outdoor air inlet on the upstream side of the air flow path and an indoor air outlet on the downstream side of the air flow path; an high efficient filtering portion disposed in the air flow path and covering at least a part of a cross section of the air flow path; a bypassing portion disposed in the air flow path in parallel with the high efficient filtering portion and covering the other part of the cross section of the air flow path; a data sensing portion disposed upstream of the bypassing portion and used to sense air quality parameters of air flowing through the data sensing portion; and a controller controlling an open/close state of the bypassing portion based on the air quality parameter sensed by the data sensing portion.

### TECHNICAL FIELD

The application relates to the field of air handling, and in particular, to an air handling unit.

### BACKGROUND

In conventional air handling units, the filter element is typically designed to fill the entire air flow path to ensure that 100% of the outdoor air flowing through the air handling unit can be filtered. However, as the environment improves, sometimes the outdoor air has better quality, for example, its PM2.5 or AQI index having met the target filtering effect of such air handling units before being filtered. At this time, if it is still required that all the outdoor air flowing through the air handling unit needs to flow through the filter element, then the lifetime of the filter element will be reduced on one hand, and causing more energy consumption on the other hand.

### SUMMARY OF THE INVENTION

The application aims at providing an energy efficient air handling unit.

To achieve the purpose of the application, according to one aspect of the application, there is provided an air handling unit comprising: an air flow path having an outdoor air inlet on the upstream side of the air flow path and an indoor air outlet on the downstream side of the air flow path; a high efficient filtering portion disposed in the air flow path and covering at least a part of a cross section of the air flow path; a bypassing portion disposed in the air flow path in parallel with the high efficient filtering portion and covering the other part of the cross section of the air flow path; a data sensing portion disposed upstream of the bypassing portion and used to sense air quality parameters of air flowing through the data sensing portion; and a controller controlling an open/close state of the bypassing portion based on the air quality parameters sensed by the data sensing portion.

Optionally, the bypassing portion covers 20%-40% of the cross-sectional area of the air flow path, and/or the high efficient filtering portion covers 60%-80% of the cross-sectional area of the air flow path.

Optionally, the ratio of the cross-sectional area of the air flow path covered by the bypassing portion to the cross-sectional area of the air flow path covered by the high efficient filtering portion is 1:2.

Optionally, the bypassing portion is located below the high efficient filtering portion in a mounted state.

Optionally, by translating, folding or rotating the bypassing portion, a cross-sectional size of the air flow path covered by the bypassing portion is adjusted.

Optionally, at least one electrically actuated throttle is further comprised, which is rotated to adjust the cross-sectional size of the air flow path covered by the electrically actuated throttle.

Optionally, the bypassing portion is used to continuously or discretely adjust the cross-sectional size of the air flow path covered by the bypassing portion.

Optionally, a primary filtering portion is further comprised, which is disposed in the air flow path and located upstream of the high efficient filtering portion and the bypassing portion.

Optionally, a heat exchanger is further comprised, which is disposed in the air flow path and located downstream of the high efficient filtering portion and the bypassing portion.

Optionally, the air quality parameters comprise an AQI index and/or a PM 2.5 index and/or a PM 10 index.

According to the air handling unit of the present application, by disposing the high efficient filtering portion and the bypassing portion side by side in the air flow path thereof, bypassing and filtering on demand is implemented without changing the precondition that the structure and the arrangement of the air handling unit is compact currently. Thereby on one hand, the utilization of the air handling unit is increased, that is, the system ineffective energy consumption is saved without changing the user comfort; on the other hand, the lifetime of the filter element is increased as well.

### BRIEF DESCRIPTION OF THE DRAWINGS

FIG. 1 is the first perspective view of one embodiment of an air handling unit of the application.

FIG. 2 is the second perspective view of one embodiment of an air handling unit of the application.

### DETAILED DESCRIPTION

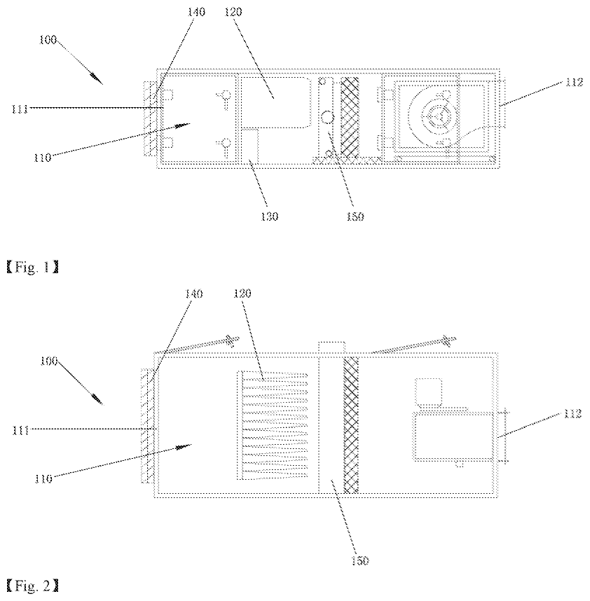

Here, the application provides an embodiment of an air handling unit in conjunction with the drawings. Referring to FIGS. 1 and 2, an air handling unit is illustrated. The air handling unit 100 comprises an air flow path 110 formed as the main body portion of the device, and the air flow path has an outdoor air inlet on the upstream side of the air flow path and an indoor air outlet on the downstream side of the air flow path, thereby achieving that the outdoor air is processed when flowing through the air flow path 110 and the processed air enters the room, in order to implement an air purification or air filtering process. Wherein the air handling process is realized by an high efficient filtering portion 120 disposed in the air flow path 110. It is notable that the high efficient filtering portion 120 in this embodiment does not completely cover the cross section of the air flow path in which the high efficient filtering portion 120 is disposed. Rather, the high efficient filtering portion 120 covers only at least a part of the cross section of the air flow path 110, whereas the other part of the cross section of the air flow path 110 is covered by a bypassing portion 130 disposed in parallel with the high efficient filtering portion 120. That is, at the cross section, if the bypassing portion 130 is fully or partially opened, most or all of the outdoor air will flow to the downstream side via the air flow path portion where the bypassing portion 130 with smaller resistance is located; and if the bypassing portion 130 is closed, most or all of the outdoor air will flow to the downstream side via the air flow path portion where the high efficient filtering portion 120 with smaller resistance is located.

Furthermore, the air handling unit further comprises a data sensing portion and a controller not shown in the drawing. Wherein the data sensing portion is disposed upstream of the bypassing portion 130 in order to sense air quality parameters of air flowing through the data sensing portion, such as an AQI index, a PM 2.5 index, or a PM 10 index. And the controller controls an open/close state of the foregoing bypassing portion 130 based on the air quality parameters sensed by the data sensing portion.

Under such an arrangement, according to the air handling unit 100 of the application, by disposing the high efficient filtering portion 120 and the bypassing portion 130 side by side in the air flow path 110 of the air handling unit 100, bypassing and filtering on demand is implemented without changing the precondition that currently the structure and the arrangement of the air handling unit 100 is compact. Thereby on one hand, the utilization of the air handling unit 100 is increased, that is, the system ineffective energy consumption is saved without changing the user comfort; on the other hand, the lifetime of the filter element is also increased.

More specifically, the bypassing portion 130 in the foregoing embodiment may be disposed to cover 20%-40% of the cross-sectional area of the air flow path 110, and the high efficient filtering portion 120 in the foregoing embodiment is disposed to cover 60%-80% of the cross-sectional area of the air flow path 110. Alternatively or optionally, the ratio of the cross-sectional area of the air flow path 110 covered by the bypassing portion 130 to the cross-sectional area of the air flow path 110 covered by the high efficient filtering portion 120 is set to 1:2. With the experimental test, the above-mentioned proportion range or ratio can well compromise a variety of factors, such as air filtering efficiency, air bypass ventilation resistance and loss of the high efficient filtering portion, and realize the balance of them.

Moreover, as a specific arrangement, the bypassing portion 130 is located below the high efficient filtering portion 120 in the mounted state.

In addition, in terms of the manner in which the bypassing portion adjusts a part of the air flow path, various valve or door schemes, the technology of which are quite mature, can be employed here. For example, by translating, folding or rotating the bypassing portion 130, the cross-sectional size of the air flow path 110 covered by the bypassing portion 130 is adjusted. More particularly, the bypassing portion may comprise at least one electrically actuated throttle, and the electrically actuated throttle is rotated to adjust the cross-sectional size of the air flow path covered by the electrically actuated throttle.

Similarly, in terms of the manner in which the bypassing portion adjusts a part of the air flow path, the bypassing portion 130 can be configured to continuously or discretely adjust the cross-sectional size of the air flow path 110 covered by the bypassing portion 130.

On the basis of the foregoing embodiment, in order to improve the service lifetime of the high efficient filtering portion 120, a primary filtering portion 140 can be disposed in the air flow path 110 and upstream of the high efficient filtering portion 120 and the bypassing portion 130, for initially filtering the large particle impurities in the air and making the high efficient filtering portion 120 mainly acting on the fine particles in the air, thereby better increasing the utilization thereof.

Optionally, the air handling unit 100 further comprises a heat exchanger 150 disposed in the air flow path 110 and located downstream of the high efficient filtering portion 120 and the bypassing portion 130, in order to heat or cool the purified air on demand and then send it into the room, which enables two functions, i.e. air purification and adjustment, at the same time.

In addition, it should be understood that the description about the filter element in the high efficient filtering portion and the primary filtering portion described herein is a well-known concept in the field of air purification, and the corresponding description exists in the correlated national standard GB/T14295, GB/T13554, so that there will not be a problem that the expression is not clear enough to those skilled in the art.

The above examples primarily illustrate the air handling unit of the application. Although only some of the embodiments of the application have been described, it will be appreciated by those skilled in the art that the present invention may be embodied in many other forms without departing from the idea and scope of the invention. Accordingly, the present examples and embodiments are to be considered as illustrative and not restrictive, and the invention may encompass various modifications and alternatives without departing from the spirit and scope of the invention as defined by the appended claims.

1. An air handling unit, characterized by, comprising:
an air flow path having an outdoor air inlet on the upstream side of the air flow path and an indoor air outlet on the downstream side of the air flow path;
an high efficient filtering portion disposed in the air flow path and covering at least a part of a cross section of the air flow path;
a bypassing portion disposed in the air flow path in parallel with the high efficient filtering portion and covering the other part of the cross section of the air flow path;
a data sensing portion disposed upstream of the bypassing portion and used to sense air quality parameters of air flowing through the data sensing portion; and
a controller controlling an open/close state of the bypassing portion based on the air quality parameter sensed by the data sensing portion.

2. The air handling unit according to claim 1, wherein the bypassing portion covers 20%-40% of the cross-sectional area of the air flow path, and/or the high efficient filtering portion covers 60%-80% of the cross-sectional area of the air flow path.

3. The air handling unit according to claim 1, wherein the ratio of the cross-sectional area of the air flow path covered by the bypassing portion to the cross-sectional area of the air flow path covered by the high efficient filtering portion is 1:2.

4. The air handling unit according to claim 1, wherein the bypassing portion is located below the high efficient filtering portion in a mounted state.

5. The air handling unit according to claim 1, wherein by translating, folding or rotating the bypass, a cross-sectional size of the air flow path covered by the bypassing portion is adjusted.

6. The air handling unit according to claim 5, characterized by, comprising at least one electrically actuated throttle which is rotated to adjust the cross-sectional size of the air flow path covered by the electrically actuated throttle.

7. The air handling unit according to claim 1, wherein the bypassing portion is used to continuously or discretely adjust the cross-sectional size of the air flow path covered by the bypassing portion.

8. The air handling unit according to claim 1, characterized by, further comprising a primary filtering portion disposed in the air flow path and located upstream of the high efficient filtering portion and the bypassing portion.

9. The air handling unit according to claim 1, characterized by, further comprising a heat exchanger disposed in the air flow path and located downstream of the high efficient filtering portion and the bypassing portion.

10. The air handling unit according to claim 1, wherein the air quality parameters comprise an AQI index and/or a PM 2.5 index and/or a PM 10 index.
